(19) United States
(12) Patent Application Publication
(10) Pub. No.: US 2005/0183113 A1
(43) Pub. Date: Aug. 18, 2005

(54) Video apparatus

(75) Inventor: Koichi Ozaki, Takefu-shi (JP)

Correspondence Address: REED SMITH LLP, Suite 1400, 3110 Fairview Park Drive, Falls Church, VA, 22042, US

(73) Assignee: Orion Electrical Company Ltd.

(21) Appl. No.: 11/023,424

(22) Filed: Dec. 29, 2004

(30) Foreign Application Priority Data
Jan. 23, 2004 (JP) 2004-016163

(51) Int. Cl. H04N 7/16; H04N 5/445; H04N 11/00; H04N 7/00

(52) U.S. Cl. 725/29; 725/25; 348/460

(57) ABSTRACT

This invention gives a restriction to a utilization time of an output apparatus to ensure that a user recognizes that the utilization time is close to an end. When a video apparatus is set into a game mode, time count is started. As the utilization time is close to an end, a brightness of a display section is gradually reduced. When the utilization time expires, an output of a signal input from a game machine is stopped. Until a prohibition time expires, the signal input from the game machine is not output, thereby prohibiting use of the game machine.

### BACKGROUND OF THE INVENTION

1. Field of the Invention

The present invention relates to a video apparatus that outputs a picture and a sound from an output apparatus such as a game machine.

2. Description of the Related Art

Recently, a game machine employed with a television receiver that serves as a video apparatus is widespread in ordinary households and the like and broadly used by people in a wide range of age brackets. However, a user is so enthusiastic about a game so that the user often spends a long time in using the game machine.

To prevent the game machine from being used for a long time, therefore, there has been proposed a technique for enabling a television receiver to set a utilization time of the game machine. Examples of the technique include one for warning a user by producing an alarm when the utilization time is close to an end, and one for forcibly turning off a power of the television receiver so that the user cannot use the game machine after expiration of the set utilization time (see, for example, Patent Literatures 1 and 2).

Patent Literature 1: Japanese Patent Application Laid-Open (JP-A) No. 2002-11242 (paragraphs 0006 to 0011, and FIG. 3)

Patent Literature 2: JP-A No. 2001-268455 (paragraphs 0007 to 0008, and FIG. 1).

However, the conventional techniques have the following disadvantages. The user who is so enthusiastic about the game is often unaware of the alarm for warning the user that the utilization time is close to an end only by notifying the user of the set utilization time. In addition, if the power of the television receiver is forcibly turned off when the set utilization time expires, the user unavoidably finishes the game machine without performing an operation of storing data on a status of the game used so far.

### SUMMARY OF THE INVENTION

It is, therefore, an object of the present invention to provide a video apparatus capable of ensuring that a user recognizes a utilization time is close to an end, and ensuring that data on a utilization status of an output apparatus such as a game machine connected to the video apparatus is stored.

According to a first aspect of the present invention, there is provided a video apparatus for outputting a picture based on an input video signal, having an input section that inputs the video signal from an output apparatus, comprising: utilization time setting means for setting a utilization time for which an input of the video signal from the input section is permitted; and warning means for, when the video signal is input from the input section, changing an output of the video apparatus with passage of time as the utilization time set by the utilization time setting means is close to an end, and for warning a user that a remaining time is short.

Namely, the warning means is a notification function of causing the user to recognize that the set utilization time is close to an end. The warning means causes the user to recognize this by sensing the notification through one of five senses such as a visual sense, an auditory sense, or a tactual sense even if the user is enthusiastic about a game, a video or the like. For example, as the set utilization time is closer to an end, the brightness of the screen is made lower. By doing so, the user can recognize that the set utilization time is close to an end, and finish storing data that represents a content of the game or the like and a utilization state of the output apparatus before the output of the picture is stopped.

The video signal may include an audio signal. In this case, the warning means may be provided so as to gradually change a sound, for example, to increase or reduce a volume as the set utilization time is closer to an end.

Further, it is preferable that the warning means gradually changes the picture input from the input section so as to make it difficult for a user to discriminate the picture with the passage of time. If so, the user finds it difficult to continue a game or the like even when the user is enthusiastic about the game or the like. It is thereby possible to ensure that the user recognize that the utilization time is close to an end.

Moreover, the video apparatus includes prohibition-of-use means for prohibiting the output of the video apparatus based on the video signal from the output apparatus when the utilization time set by the utilization time setting means expires. The prohibition-of-use means is means for prohibiting the output of the video signal input from the input section. Namely, even if the video signal is input through the input section, no picture is output for a certain period of time. This can thereby prohibit the user from using the output apparatus for the time other than the set utilization time. A prohibition time for which the picture is not output is not limited to a certain time. For example, when the utilization time expires, the time after the expiration may be set as the prohibition time.

The prohibition time for which the user is prohibited from using the output apparatus for the certain time can be set by prohibition time setting means. Namely, the user can arbitrarily set the prohibition time in, for example, hours or date.

According to a second aspect of the present invention, there is provided a television receiver, having an input section that inputs a video signal from an output apparatus, for outputting a picture based on the video signal input to the input section, wherein the input section includes an input terminal for connecting a game machine serving as the output apparatus to the television receiver; comprising: utilization time setting means for permitting the video signal to be input to the input terminal to which the game machine is connected, and for setting a utilization time for which a use of the game machine is permitted; and warning means for changing a brightness of the picture output to the television receiver as the utilization time thus set is close to an end, thereby warning the user.

Namely, the warning means for notifying the user that the set utilization time for a game is close to an end gradually reduces the brightness of the picture as the utilization time is closer to an end. The warning means thereby causes the user to recognize this by sensing the notification through one of five senses even if the user is enthusiastic about a game. By doing so, the user can finish an operation of storing data on a state of the game used so far before the set utilization time expires.

The television receiver further includes prohibition-of-use means for prohibiting an output based on the video signal from the game machine when the utilization times set by the utilization time setting means expires.

The prohibition-of-use means can ensure turning off the television receiver when the utilization time expires. It is, therefore, possible to prevent the user from using the game machine for a longer time than the set utilization time. Furthermore, the television receiver includes prohibition time setting means for setting a prohibition time for which an output of the picture based on the video signal input from the input terminal connected to the game machine is prohibited. It is thereby possible to prohibit the use of the game machine for a certain time after expiration of the utilization time.

As can be seen, according to the present invention, when the video signal is input from the input section, it is possible to ensure that the user recognizes that the utilization time is close to an end by sensing this through one of the user's five senses. Further, if the user plays a game by connecting the game machine serving as the output apparatus to the television receiver which is an example of the video apparatus, the user is made to recognize that the utilization time is close to an end even while the user is enthusiastic about the game. The user can thereby store the content of the game before the expiration of the utilization time.

Furthermore, by setting the prohibition time after expiration of the utilization time, it is possible to prohibit continuous use of the output apparatus.

### BRIEF DESCRIPTION OF THE DRAWINGS

FIG. 1 is a perspective view that depicts that a game machine is connected to a television receiver which is one example of a video apparatus according to the present invention;

FIG. 2 is a control block diagram that depicts an entirety of the video apparatus;

FIG. 3 is a control block diagram that depicts an interior of a control section;

FIG. 4 depicts a menu screen;

FIG. 5 depicts a game mode-setting screen;

FIG. 6 depicts a display section brightness setting screen; and

FIG. 7 is a flowchart of an operation performed by the television receiver in a game mode.

### DESCRIPTION OF THE PREFERRED EMBODIMENT

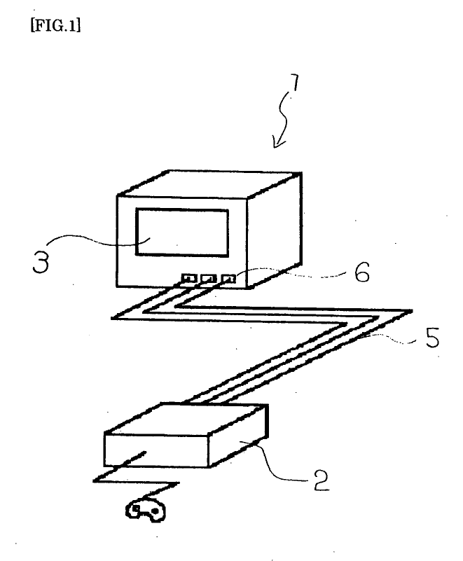

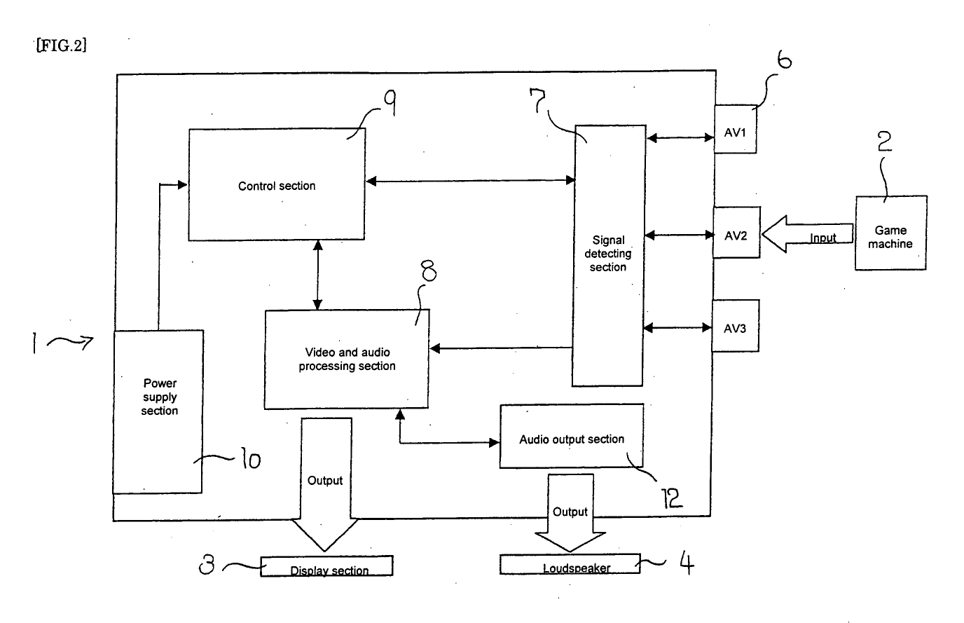

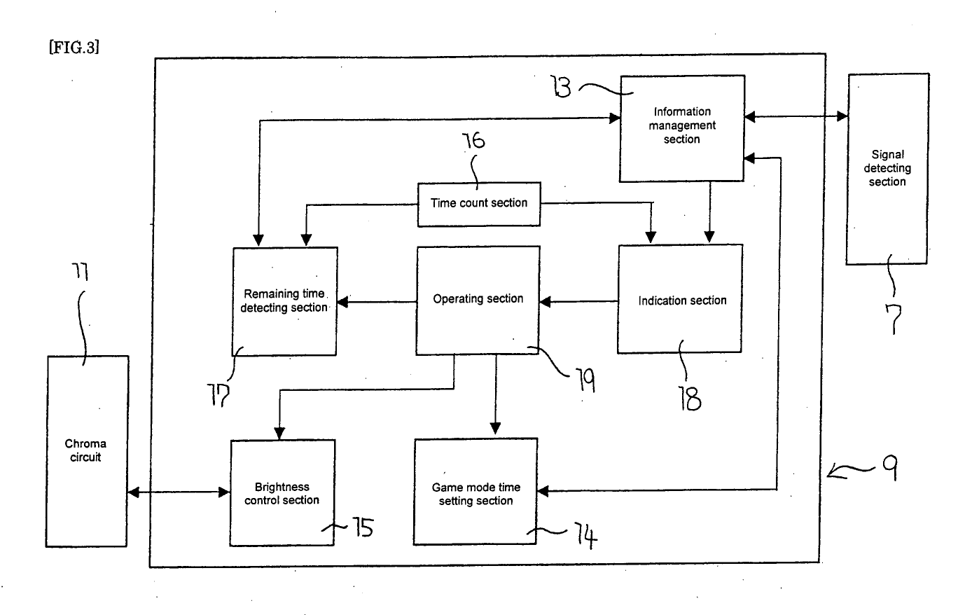

An embodiment of the present invention will be described hereinafter with reference to the drawings. FIG. 1 is a perspective view that shows that a game machine is connected to a television receiver which is one example of a video apparatus according to the present invention. FIG. 2 is a control block diagram that depicts an entirety of the video apparatus. FIG. 3 is a control block diagram that depicts an interior of a control section.

As shown in FIGS. 1 and 2, a television receiver 1 according to the present invention performs a predetermined processing on a signal output from a game machine 2 that serves as an output apparatus, and outputs the processed signal as a picture and a sound. The television receiver 1 includes a display section 3 that displays the picture, a loudspeaker 4 that outputs the sound, input terminals 6 each serving as an input section to which the game machine 2 is connected through an AV cable 5, a signal detecting section 7 that detects an external signal input from the game machine 2, a video and audio processing section 8 that performs a predetermined processing on the signal detected by the signal detecting section 7, and that outputs the processed signal to the display section 3 and the loudspeaker 4, a control section 9 that controls the signal detecting section 7 and the video and audio processing section 8, and a power supply section 10 that supplies a power for activating the control section 9.

The display section 3 is a display screen provided on a front surface of a cabinet for displaying a picture. The input terminals 6 are provided outside of the cabinet and each of a shape of an ordinarily-used pin.

The signal detecting section 7 detects whether the external signal such as a video signal or an audio signal is input from one of the input terminals 6, and transmits a detection result to the control section 9 if the external signal is input. The signal detecting section 7 also outputs the external signal to the video and audio processing section 8 in response to a command from the control section 9. Further, the signal detecting section 7 detects to which of the plural input terminals 6 the external signal is input. In response to a command from the control section 9 based on the detection result, the signal detecting section 7 switches to output the external signal input from one of the input terminals 6 to the video and audio processing section 8. In other words, the signal detecting section 7 includes a switchover function of switching over one of inputs from the input terminals 6 to another.

The video and audio processing section 8 includes a chroma circuit 11 that performs a processing, e.g., a brightness adjustment, on the video signal, and an audio circuit (not shown) that processes an output of a sound or the like. The video and audio processing section extracts a video signal and an audio signal from the external signal transmitted from the signal detecting section 7. The video signal and the audio signal thus extracted are subjected to predetermined processing based on the command from the control section 9, respectively. The video signal is output to the display section 3 whereas the audio signal is output to the loudspeaker 4 through an audio output section 12.

The control section 9 is composed by an ordinary microcomputer that includes therein a random-access memory (RAM), a read-only memory (ROM), and a central processing unit (CPU). As shown in FIG. 3, the control section 9 includes an information management section 13 that manages information such as a utilization time and a prohibition time, a game mode time setting section 14 that sets the utilization time and the prohibition time, a brightness control section 15 that transmits a brightness signal to the chroma circuit 11 so as to change a brightness of the display section 3, a time count section 16 that counts a time, a remaining time detecting section 17 that counts a remaining time of the utilization time or the prohibition time, an indication section 18 that issues a command to an operating section 19 based on the information stored in the information management section 13, and the operating section 19 that causes the game mode time setting section 14, the brightness control section 15, and the remaining time detecting section 17 to operate based on the command from the indication section 18 and time information from the time count section 16.

The “utilization time” means herein a time for which the external signal input from one of the input terminals 6 is output to permit use of the game machine 2. The “prohibition time” means herein a time for which even if the external signal is input from one of the input terminals 6, the external signal is not output to prohibit the use of the game machine 2. Settings of these times are input using operation keys provided on an operating device (not shown), e.g., a remote controller, included in the television receiver 1 according to a screen displayed on the display section 3.

The game mode time setting section 14 stores the setting information, such as the utilization time, the prohibition time, and the brightness of the display section 3, input using the operation keys on the operating device (not shown), in a nonvolatile memory such as a flash memory.

The information management section 13 transmits a command to permit or prohibit inputting the external signal, to the signal detecting section 7 based on the setting information stored in the game mode time setting section 14 and the remaining time counted by the remaining time detecting section 17 when the external signal is input from one of the input terminals 6. Further, the information management section 13 determines a present state based on the setting information and outputs a content of the determination to the indication section 18.

The indication section 18 sets an operation of the game mode time setting section 14, the brightness control section 15, or the remaining time detecting section 17 according to the determination content, and indicates the operating section 19 to transmit an operation command. The indication section 18 includes therein a volatile memory that temporarily stores the determination content from the information management section 13.

The operating section 19 transmits the operation command to the brightness control section 15, the remaining time detecting section 17, or the game mode time setting section 14 based on the indication from the indication section 18.

The brightness control section 15 changes a brightness of the picture output to the display section 3. Namely, the brightness control section 15 transmits the brightness signal for determining the brightness, to the chroma circuit 11. The “brightness signal” means a signal that indicates the number of steps representing the brightness of the screen of the display section 3.

The time count section 16 includes an oscillator (not shown) that generates a frequency clock signal, and counts the time at a timing based on the generated clock signal. The time count section 16 can count the time even if the power is cut off.

The remaining time detecting section 17 starts time count simultaneously with input of the external signal to the video and audio processing section 8. The remaining time detecting section 17 calculates the remaining time of the set utilization time or prohibition time. The remaining time detecting section 17 outputs a calculation result to the information management section 13. That is, the remaining time detecting section 17 includes a time count function of counting the remaining time in response to the operation command from the operating section 19.

Specifically, the control section 9 acquires a detection result as to whether the signal is input from one of the input terminals 6, from the signal detecting section 7. If the external signal is input, the control section 9 controls the video and audio processing section 8 to output the input signal to the display section 3 for the utilization time set in advance. In addition, the control section 9 transmits the brightness signal to the chroma circuit 11 through the brightness control section 15 so that the screen of the display section 3 has the brightness set relative to the remaining time. Further, the control section 9 can make time management such as the time count of the utilization time and the time count of the prohibition time, by the time count performed by the remaining time detecting section 17.

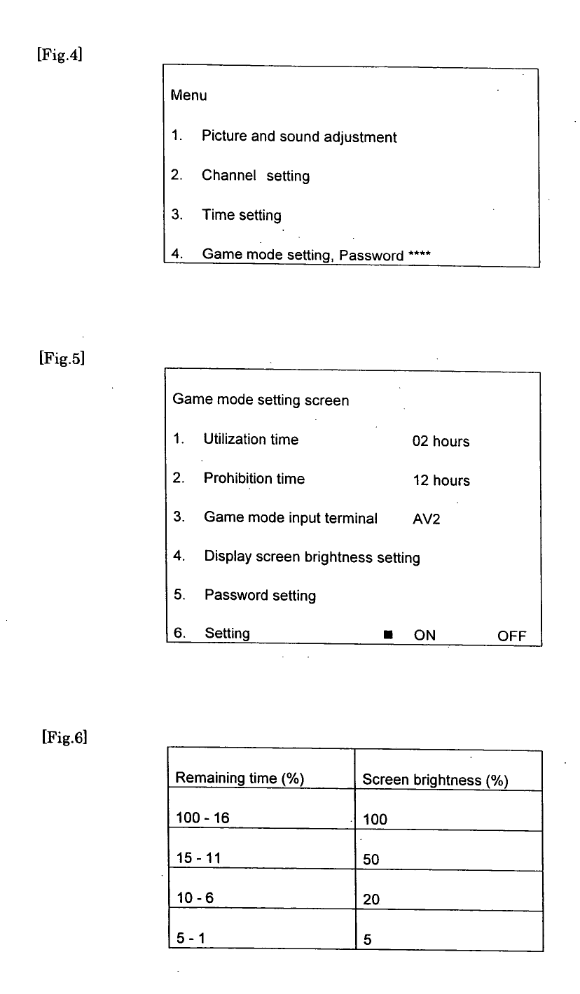

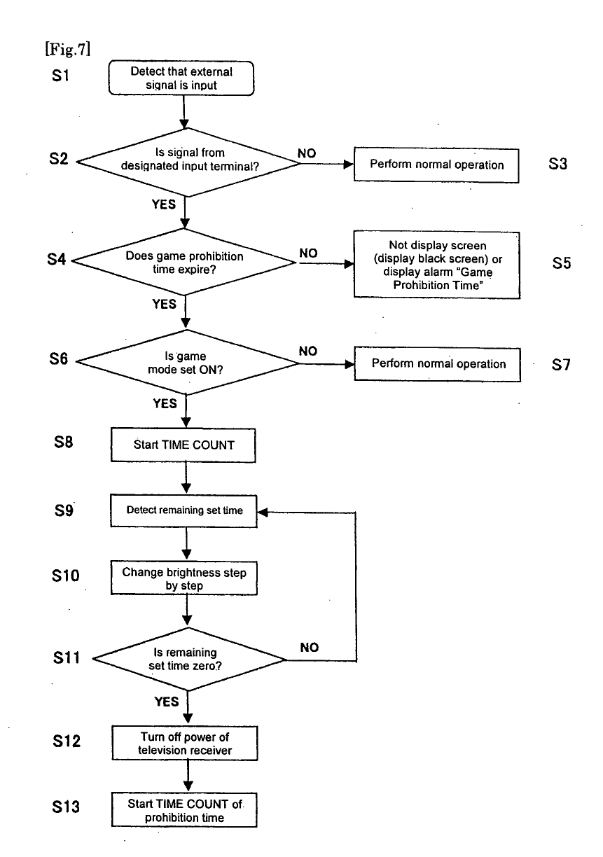

Referring to FIGS. 4, 5, and 6, procedures for storing information on the game mode setting and outputting the set information to the information management section 13 will next be described. FIG. 4 depicts a menu screen. FIG. 5 depicts a game mode setting screen. FIG. 6 depicts a display section brightness setting screen.

First, the television receiver 1 is set into a menu screen mode by operating a menu key on the operating device, and the menu screen, as shown in FIG. 4, is displayed on the display section 3. On the menu screen, “game mode setting” is selected to set the television receiver 1 into a game mode setting mode. When selecting the “game mode setting”, a user inputs a password to the television receiver 1. By doing so, a third person cannot change various settings including the settings of the utilization time and the prohibition time. For example, only a parent can set the game mode and a child or the like who uses the game machine 2 cannot freely change the settings.

The game mode setting screen, as shown in FIG. 5, is displayed on the display section 3. On the game mode setting screen, the user inputs items as to settings of the utilization time, the input terminal 6 to be used, the prohibition time, the brightness of the display section 3, the password, and whether to execute the game mode setting. The user inputs the respective items by operating the operation keys on the operating device. The user inputs the utilization time and the prohibition time in hours or minutes. Alternatively, the user may input designated dates and time as the utilization time and the prohibition time, respectively.

To set the input terminal 6 to be used, a number allocated to the input terminal 6 connected to the game machine 2 is input. For example, if the second input terminal 6 is connected to the game machine 2, “AV2” is input. Namely, the user can arbitrarily select the desired input terminal 6 used in the game mode. Alternatively, a plurality of input terminals 6 can be simultaneously selected.

Since the brightness of the display section 3 and the password are set in advance, the user does not need to make particular settings thereto. However, the brightness of the display section 3 and the password can be arbitrarily changed as desired by the user.

The brightness of the display section 3 is set to be gradually changed. As shown in FIG. 6, the brightness of the display section 3 is set relative to the remaining time. If the brightness of the display section 3 is to be changed, the user selects a brightness setting item. By doing so, the user can arbitrarily change the degree of the brightness of the display section 3 relative to the remaining time.

If the password is to be changed, the user inputs a present password and then inputs a new password. This can thereby prevent the password from being easily changed. This setting is made using the operation key on the operating device simultaneously with the input of the respective setting items.

With reference to FIG. 7, an operation of the television receiver 1 in the game mode according to this embodiment will be described. FIG. 7 is a flowchart that depicts an operation performed by the television receiver 1 in the game mode.

The game machine 2 is connected to the input terminal 6 designated to be used in the game mode through the AV cable 5. When the video signal is input from the game machine 2 to the connected input terminal 6, the signal detecting section 7 detects that the external signal is input (at a step S1). At this time, the signal detecting section 7 detects to which of the input terminals 6 the external signal is input, and transmits the detection result to the information management section 13.

The information management section 13 compares the detection result received from the signal detecting section 7 with information on the input terminal 6 designated to be used (at a step S2). If the detected input terminal 6 is equal to the designated input terminal 6, the information management section 13 determines whether the prohibition time expires based on calculation information output from the remaining time detecting section 17 (at a step S4). If the prohibition time expires, the information management section 13 determines whether the television receiver 1 is set in the game mode (at a step S6). If the television receiver 1 is set in the game mode, the signal detecting section 7 outputs the external signal to the video and audio processing section 8. As a result, the user of the game machine 2 can start a game.

If the external signal is not input from the designated input terminal 6 or the television receiver 1 is not set into the game mode, the television receiver 1 performs an ordinary operation (at a step S3 or a step S7). If the prohibition time does not expire, the external signal is output from the signal detecting section 7 to the video and audio processing section 8. The video and audio processing section 8 does not, however, process the signal. If so, a black screen is displayed on the display section 3 or an alarm such as “game prohibition time” is displayed on the display section 3. Further, the signal detecting section 7 switches the input terminal 6 used to output the signal to the video and audio processing section 8, thereby shutting off the input of the signal from the game machine 2 (at a step S5).

When the user starts playing the game, the indication section 18 indicates the remaining time detecting section 17 to start counting a time through the operating section 19 (at a step S8). This time count starts simultaneously with the input of the external signal to the video and audio processing section 8.

During execution of the game mode, the information management section 13 monitors the remaining time based on the set information and the time counted by the remaining time detecting section 17 (at a step S9, S10, or S11). When the remaining time is shorter, the brightness of the display section 3 is lower step by step. The information management section 13 thus controls the brightness control section 15 through the indication section 18 and the operating section 19 so that the display section 3 has the brightness set according to the remaining time.

To reduce the brightness of the display section 3 step by step, the number of steps that represents the brightness of the display section 3, for example, is gradually reduced. When the remaining time of the utilization time is equal to or shorter than 15% of the entire utilization time, the brightness of the display section 3 is reduced to 50% of the original brightness thereof. Namely, if the original brightness of the display section 3 has 30 steps, the brightness is reduced to 15 steps.

In this way, the number of steps that represents the brightness is changed according to the remaining time. It is noted that the darkest display section 3 has a brightness that does not adversely influence a user's end operation for the game or the like.

The control section 9 makes the brightness of the display section 3 lower as the utilization time is closer to end. When the utilization time expires, the signal input from the designated input terminal 6 is not output to the video and audio processing section 8. If so, the user notices an abnormality of the screen and recognizes that the utilization time is to expire. The user can recognize visually that the utilization time is to expire, even when the user is enthusiastic about the game or the like. The user can, therefore, finish the end operation such as storage of a content of the game within the utilization time.

When the utilization time expires, the control section 9 turns off the power of the television receiver 1 (at a step S12). Alternatively, the power of the television receiver 1 may be kept to be turned on without being turned off. In this case, when the external signal is input, the output of the signal is shut off.

When the utilization time expires, the prohibition time for which the external signal input from the designated input terminal 6 is not output to the video and audio processing section 8 starts (at a step S13). The remaining time of the set prohibition time is counted by the remaining time detecting section 17, and the signal input from the designated input terminal 6 is not output until the prohibition time expires.

If the input of the signal from the input terminal 6 is stopped during the utilization time, i.e., the use of the game machine 2 is stopped during the utilization time, the control section 9 stops counting the time at the moment of the stoppage of the input from the input terminal 6. If the signal is input again to the designated input terminal 6, the control section 9 starts the time count at the moment of the detection of the signal by the signal detecting section 7 continuing from the previously stopped time. The user can thereby surely use the set utilization time. If the game is finished during the utilization time, it may be determined that the game machine 2 is not used and the utilization time may be changed to the prohibition time. By doing so, a certain time interval is always kept after the use of the game machine 2 or the like. It is, therefore, possible to prevent the use of the game machine 2 or the like for a long time.

Needless to say, the present invention is not limited to the above-stated embodiment, and various changes and modifications can be made within the scope of the present invention. For example, the warning means for warning the user by changing the brightness of the display section 3 is provided according to the embodiment. Alternatively, warning means for warning the user by changing an output of the sound may be provided. In the latter case, the output of the sound is made lower as the utilization time is closer to end.

Further, as the utilization time is closer to end, the display of the screen may be made smaller in size or the display of the screen may be turned on and off. Besides, a time count number indicating the remaining time of the utilization time may be displayed on the screen of the display section. In the latter case, the displayed count number is made larger as the utilization time is closer to end. By doing so, the user can recognize that the utilization time is closer to end and grasp the remaining time.

Moreover, the number of the input sections allowed to set the game mode is not limited to one but may be two or more. It is thereby possible to prevent the game machine 2 from being used continuously by connecting the game machine 2 to a different input section after the expiration of the utilization time.

The output apparatus is not limited to the game machine but may be a videotape apparatus, a DVD apparatus or the like. The video apparatus is not limited to the television receiver but may be any video apparatus that includes the external input terminal such as a projector or a monitor. Further, a television game machine in which the television receiver and the game machine are integrally provided can be used.

Moreover, the television receiver and the game machine may be communicable with each other. When the utilization time is close to an end, a drive signal may be transmitted from the television receiver to the game machine to vibrate the game machine so that the user can recognize that the utilization time is close to an end.

1. A video apparatus for outputting a picture based on an input video signal, having an input section that inputs the video signal from an output apparatus, comprising:
utilization time setting means for setting a utilization time for which an input of the video signal from the input section is permitted; and
warning means for, when the video signal is input from the input section, changing an output of the video apparatus with passage of time as the utilization time set by said utilization time setting means is close to an end, and for warning a user that a remaining time is short.

2. The video apparatus according to claim 1, wherein
the warning means gradually changes the picture input from the input section so as to make it difficult for a user to discriminate the picture with the passage of time.

3. The video apparatus according to claim 1, further comprising:
prohibition-of-use means for prohibiting the output of the video apparatus based on the video signal from the output apparatus when the utilization time set by the utilization time setting means expires.

4. A television receiver, having an input section that inputs a video signal from an output apparatus, for outputting a picture based on the video signal input to the input section, wherein the input section includes an input terminal for connecting a game machine serving as the output apparatus to the television receiver; comprising:
utilization time setting means for permitting the video signal to be input to the input terminal to which the game machine is connected, and for setting a utilization time for which a use of said game machine is permitted; and
warning means for changing a brightness of the picture output to the television receiver as said utilization time thus set is close to an end, thereby warning the user.

5. The television receiver according to claim 4, wherein
the warning means gradually reduces a brightness of the picture as the utilization time is close to an end.

6. The television receiver according to claim 4, further comprising:
prohibition-of-use means for prohibiting an output based on the video signal from the game machine when the utilization time set by the utilization time setting means expires.

7. The television receiver according to claim 6, further comprising:
prohibition time setting means for setting a prohibition time for which an output of the picture based on the video signal input from the input terminal connected to the game machine is prohibited.

8. The video apparatus according to claim 2, further comprising:
prohibition-of-use means for prohibiting the output of the video apparatus based on the video signal from the output apparatus when the utilization time set by the utilization time setting means expires.

9. The television receiver according to claim 5, further comprising:
prohibition-of-use means for prohibiting an output based on the video signal from the game machine when the utilization time set by the utilization time setting means expires.
